(19) United States
(12) Patent Application Publication
(10) Pub. No.: US 2004/0232170 A1
(43) Pub. Date: Nov. 25, 2004

(54) Anti-monster kit and method of use

(76) Inventors: Jonathan Glick, Chicago, IL (US); Jody L. Factor, Naperville, IL (US)

Correspondence Address: FACTOR & LAKE, LTD, 1327 W. WASHINGTON BLVD., SUITE 5G/H, CHICAGO, IL, 60607, US

(21) Appl. No.: 10/446,270

(22) Filed: May 23, 2003

(51) Int. Cl. B67D 5/40

(52) U.S. Cl. 222/383.1

(57) ABSTRACT

A kit and method for using the kit to aid in alleviating the childhood fears that are associated with fictitious negative entities, such as monsters, ghosts, ghouls, and the like. The kit includes a spray container, and at least two fluids capable of insertion into the spray container, wherein the fluids include a marking agent that is associated with predetermined external criteria, such as the time of the day, room in the house, or name of the monster with which the child's fears are associated. A user can select an appropriate fluid based on the particular criteria associated with the fear, insert that fluid into the spray container, and then spray the fluid in an appropriate location to, in turn, alleviate the fears of the child about the negative entity.

### BACKGROUND OF THE INVENTION

1. Field of the Invention

The present invention is directed generally to the field of novelty items used by parents and other individuals in guardianship or similar roles in aiding children in overcoming adolescent and pre-adolescent fears of ghosts, goblins, monsters, and other fictitious creatures which cause a negative rear reaction in children.

2. Background Art

Childhood fears of the dark, monsters, and other imaginary entities are a right of passage nearly all children face. Parents and guardians are similarly faced with difficulties raised by these fears, as they present a barrier to bedtime, bathroom time, and other essential tasks that are a general part of every day living. These difficulties are compounded by the impact the fear of these “negative entities” has on children.

Like many childhood fears, the fears of negative entities often pass with time. As children grow older, they become less afraid of what they can't see or don't know, instead relying on their experience that there is in fact nothing harmful under the bed or in the closet. But, achieving this level of comfort with the unknown can be hard, and numerous methods and/or devices have been used to ease this difficult transition for children.

For example, fear of the dark has caused a number of parents to utilize night lights and other illumination mechanisms to provide a source of comforting light for children. Studies have shown, however, that the use of night lights may decrease the efficacy of a child's sleep, and subsequently affect their work at school.

Alternative methods have also been used, such as giving a child a stuffed animal as a companion, reading pleasant bedtime stories before bed, etc.

Although many of these methods and/or devices are effective in helping children deal with the fears associated with negative entities, there is a need for a more proactive, interactive and individualized solution for certain children.

It is thus an object of the present invention to provide a proactive and interactive “anti-monster” kit for parents/guardians and/or children to use in alleviating the fears associated with negative entities.

It is additionally an object of the present invention to provide a new and novel method for using such a kit.

These and other objects will become apparent to one of ordinary skill in the art in light of the specification, claims and drawings attached hereto.

### BRIEF DESCRIPTION OF THE DRAWINGS

FIG. 1 depicts a plan view of one preferred embodiment of the invention incorporating a generic spray bottle;

FIG. 2 depicts another plan view of another preferred embodiment of the invention that also incorporates a generic spray bottle;

FIG. 3 depicts yet another plan view of another preferred embodiment of the invention, but includes an aerosol-type spray bottle;

FIG. 4a depicts a plan view of a spray container with a design incorporated therein;

FIG. 4b depicts a plan view of an anti-monster kit with a design thereon; and

FIG. 5 depicts a plan view of the elements of the anti-monster kit, assembled completely into a kit container.

### SUMMARY OF THE INVENTION

The present invention, described further herein, includes a kit for alleviating fears associated with fictitious negative entities, which includes a container having a spray capability, at least two fluids for insertion into the container, with each fluid having a separate marking agent associated therewith such that each marking agent is associated with one or more predetermined external criteria. The fluid can be a liquid or a gas, or any other fluidic medium capable of spraying from a conventional spray bottle. A parent and/or guardian can use such a kit to enable a child to proactively and interactively face, address and overcome childhood fears of fictitious negative entities.

The marking agents associated with the fluids in the kit can be combined directly with the fluid, or can be included as a separate element of the kit so that it can be thereafter combined with a fluid by a user. The marking agents may include dyes of different colors, a particular fluid such as a disappearing ink or simply ink itself, or different scents, among other conventional marking agents. The marking agent may be premixed with the fluid, or may be included as a separate element within the kit that is capable on mixing with the fluid. The separate elements could include mixing tablets, a dissolvable powder, or even a solvable liquid dye.

Generally, the marking agents are associated with predetermined external criteria, which aid a parent and/or guardian in the selection of an appropriate kit/fluid. The criteria can include any number of factors, including the gender of a person, such as the child, the days of the week, the time of the day, the month of the year, public holidays, different household room names, different household furniture items, two or more fictional characters, or two or more non-fictional characters.

A kit would preferably come pre-loaded with two or more pre-marked fluids, or mixing packets/powders/dyes. Alternatively, the kit can be used with refills for the fluids, wherein the refills include a fluid with a marking agent, or a packet of marking agent that can be mixed with a fluid, either of which can be inserted into the container of the kit for spraying. Regardless of the particular form of the vessel for the fluids, a preferred embodiment of the invention includes that each fluid is contained in a refill container and the refill container contains identifying markings that correspond to the marking agent.

In another preferred embodiment of the invention, the container additionally comprises a marking design and the marking design is additionally associated with the predetermined external criteria.

The present invention additionally includes a method for alleviating fears associated with fictitious negative entities, which includes the steps of (1) identifying one or more criteria associated with a fictitious negative entity; (2) selecting an appropriate fluid based on the criteria, wherein the fluid includes a marking, agent associated with the identified criteria; (3) inserting the fluid into a container having a spray capability; and (4) spraying the fluid into a predetermined location to, in turn, alleviate fears associated with the fictitious negative entity. Such a method can be beneficially utilized with the above-described kit.

### DETAILED DESCRIPTION OF THE INVENTION

While this invention is susceptible of embodiment in many different forms, there is shown in the drawings and will be described in detail, several specific embodiments with the understanding that the present disclosure is to be considered as an exemplification of the principles of the invention and is not intended to limit the invention to the embodiments illustrated.

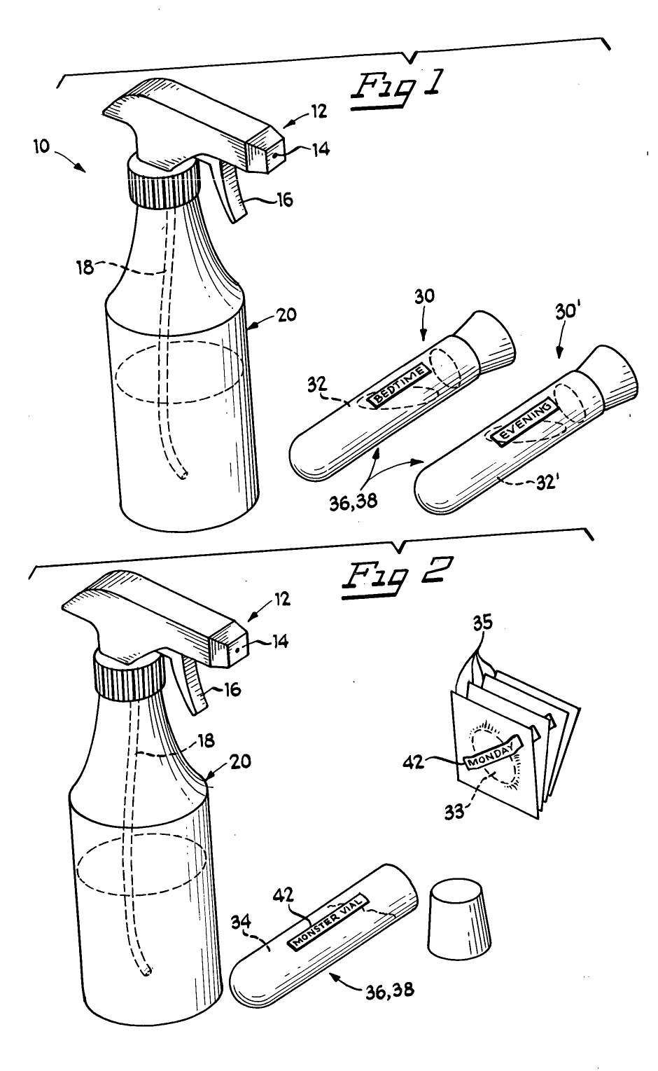

The present invention can generally be described as an “Anti-Monster Kit” and a method for using such a kit. Such a kit is shown in FIGS. 1-5, as generally including container 10 capable of spraying a fluid, and at least two fluids 30, 30′ for insertion into container 10. Fluids 30, 30′ are generally associated with individual marking agents 32, 32′, either integrally mixed with fluids 30, 30′, or as separate elements that can be mixed with fluids 30, 30′. Marking agents 32, 32′, as will be explained in detail, help identify the fluids' relation to a predetermined external criterion, such that selection of an appropriate fluid 30, 30′ to be associated with container 10 is achieved. Together, these elements enable a parent or guardian to help alleviate a child's fears of monsters and the like.

Container 10 is shown generally in FIG. 1 as a conventional spray bottle, such as a spray bottle used in general gardening applications or cleaning applications. Container 10 includes spray head 12 having nozzle 14, trigger 16, and conduit 18, and reservoir 20 for retaining a fluid. As with conventional spray bottles, container 10 enables a fluid to be delivered from reservoir 20 via nozzle 14, by depressing trigger 16 and pulling fluid from reservoir 20 via conduit 18.

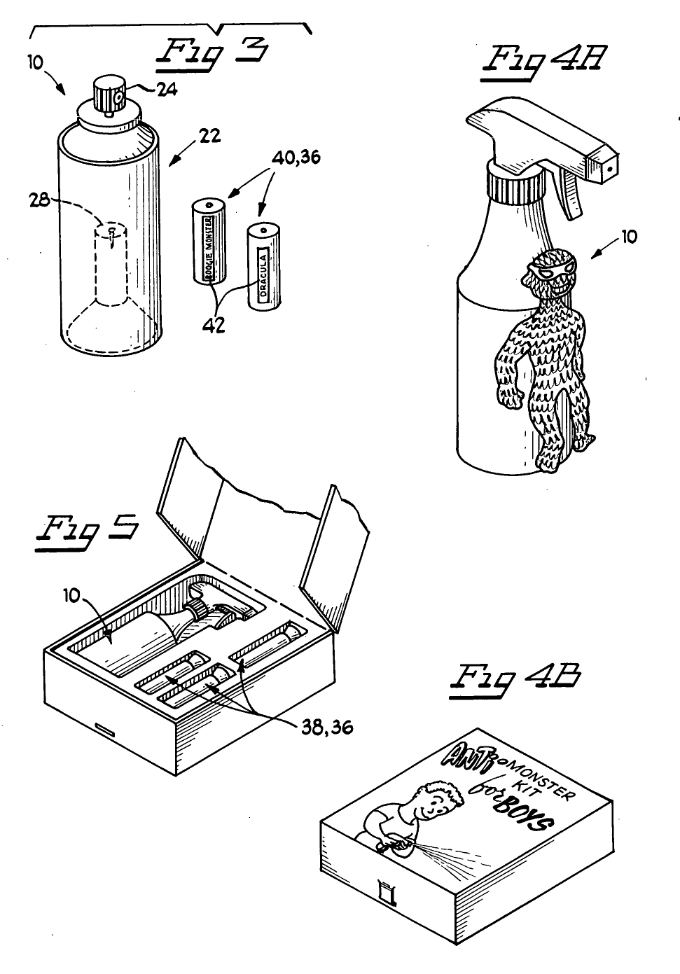

An alternative embodiment for container 10 is shown in FIG. 3 as a conventional aerosol spray bottle. Container 10 is shown in FIG. 3 as having aerosol shell 22, with spray nozzle 24 thereon, and refill insertion chamber 26 inside shell 22. Refill insertion chamber 26 includes interface 28 for enabling introduction of fluid 30, 30′ into aerosol shell 22. Depending upon the structure of refill 40, discussed below, interface 28 may be a nozzle, or puncture device, which interacts with refill 40 to introduce a fluid into container 10 for spraying.

FIGS. 1-5 exemplify particularly advantageous embodiments for container 10. It should be noted, however, that any conventional spray apparatus could similarly suffice.

Fluid 30 provides the substance to be sprayed by container 10, and which is associated with marking agent 32. Fluid 30 can include any number of fluidic substances, such as water, oil, or an appropriate carrier gas. In a preferred embodiment shown in FIG. 1, fluid 30 comprises water, which is associated with a coloring dye as marking agent 32. Specifically, fluid 30 in FIG. 1 is preferably encased within fluid container 36, such as vial 38. Fluid 30 is thus pre-mixed with marking agent 32, creating a pre-colored water solution for introduction into container 10.

Alternatively, fluid 30 could be a pure substance, while marking agent 32 is included in a form capable of mixing with fluid 30. For example, as shown in FIG. 2, marking agent 32 could comprise mixing tablets 33, or mixing powder 34, contained within an individualized packet 35. Additionally, marking agent 32 could comprise a compatible/solvable fluid, such as a fluid dye. In such an embodiment, vial 38 may be either pre-filled with fluid 30, or may be filled with fluid 30, such as water, by a user at the time of use. Thereafter, as an example, the contents of packet 35 may be added to vial 38, creating the same dyed effect seen in the pre-mixed versions of vials 38 in FIG. 1.

As long as fluid 30 is in liquid form, as shown in FIGS. 1 and 2, marking agent 32 and fluid 30 can be combined in any number of conventional ways, including pre-mixing (as in FIG. 1), or by a user at the point of use (as in FIG. 2). One alternative embodiment to FIGS. 1 and 2, however, may be seen in FIG. 3. In FIG. 3, container 10 comprises an aerosol shell 20, capable of spraying fluid 30 via aerosol means. Although an aerosol container can propel both liquid and gas fluids, a preferred embodiment of the present invention includes fluid 30 as a gas. Obviously, if fluid 30 is a gas, conventional mixing techniques become more difficult, and nearly impossible for an at-home user. Thus, when fluid 30 is a gas, it is preferred that each fluid 30 is retained within a pre-filled fluid container 36, Such as refill 40, which contains a pre-mixture of fluid 30 and marking agent 32.

Refill 40 comprises any number of known conventional structures capable of providing an aerosol refill to aerosol shell 20, as in FIG. 3. Generally, however, refill 40 comprises a cylindrical sealed container, with an external shape that is configured to cooperate with refill insertion chamber 26, and interface 28. Interface 28 may include a nozzle-type structure, in which case refill 40 includes a mating needle structure or insertion into the nozzle. Similarly, interface 28 may include a puncture needle, and refill 40 would then include either a compatible nozzle-type structure, or an aperture with a seal that can be punctured/ruptured appropriately. Such structures are well known in the art, and any conventional aerosol refill system can be substituted herein, without deviation from the scope of the present invention.

Regardless of the particular form used for fluid 30, each kit should contain at least two fluids 30, 30′ which are individually associated with separate marking agents 32, 32′. Each marking agent 32 provides a separate means for identification of fluid 30 associated therewith. Marking agent 32 can comprise any number of conventional markers, depending on fluid 30. If fluid 30 is a liquid, marking agent 32 could comprise a compatible coloring dye and/or a dissolvable scent. In fact, fluid 30 could itself comprise marking agent 32, such as if fluid 30 were an ink or other colored fluid. One embodiment that provides special advantages would include fluid 30 comprising a disappearing ink, so that fluid 30 additionally met the functions of marking agent 32. Alternatively, if fluid 30 is a gas, marking agent 32 may preferably be a scent. The particular marking agent 32 associated with each fluid 30 provides a means for identifying the particular fluid 30, either before or after fluid 30 is delivered using container 10.

To further help identify an appropriate fluid for use with container 10, fluid container 36 or packet 35 preferably includes identifying marking 42, such as a label or other identifying information, which specifies information about one of marking agent 32 or fluid 30. Particularly, it is preferred that identifying marking 42 in some way identifies the predetermined external criteria to which fluid 30 relates.

For example, the predetermined external criteria which may be used to select the appropriate fluid 30 for use with container 10 can comprise any number of categories of people, places and things. Generally, however, the criteria should be related to people, places and things which children associate with fears and apprehension about fictitious entities, such as monsters, ghosts and the like. For example, if a child is particularly afraid of monsters at or near his/her bedtime, a predetermined external condition could be the particular time of the day. Thus, as in FIG. 1, at least one of vials 38 could be marked using identifying marking 42 with the words “BEDTIME,” or “EVENING,” or the like.

Alternative conditions which may be used as identifying criteria for fluid 30 include the day of the week (i.e. Monday, Tuesday, etc.), the month of the year (i.e. January, February, etc.), a gender (i.e. male or female), particular public holidays (i.e. Halloween), household room names (i.e. closet, bedroom, bathroom, etc.), household furniture items (i.e. bed, couch, etc.). fictional characters (e.g. monster names, or superhero names), or non-frictional characters (e.g. mom, dad, or public figures such as sports heroes). In fact, any criteria at all may be associated with marking agent 32, as long as that particular criterion provides a beneficial association between the child and the alleviation of the particular fear.

The kit and/or container 10 within the kit can also include markings, structures, colors or even sounds that relate to the criteria mentioned above. For example, as shown in FIG. 4a , container, 10 can include a design integrated into its structure, such as a superhero, or other character. Alternatively, the design could be a sticker, a color, or other markings that can designate to a user of the kit one or more of the above criteria. Additionally, as shown in FIG. 4b , the kit itself can be labeled with a particular criterion, such as “Anti-Monster Kit for Boys.” These markings can be used by themselves, or in addition to the marking agents 32 described above that are used with fluid 30.

The entire kit, described above as including container 10, and at least two fluids 30, 30′, preferably in vials 38 or other similar containers, are combined together in pre-packaged case, as seen in FIG. 5. This package provides an ideal marketing tool for sale in stores, storage by a user, and subsequent use by a user. It should be noted, also, that individual replacement fluids may be incorporated into such a device. Thus, container 10 can be re-used with fluid replacements, such as replacement vials of fluids, or with fluids mixed with replacement packages of marking agents.

The above-described kit is simple and effective to use with children of a variety of ages. In order to use the kit, a user needs to (1) identify an external criteria associated with an occurrence of a negative entity, such as that it occurs at night, under the bed, or can only be scared away by mom or dad then (2) select an appropriate fluid from the kit of the present invention, wherein the fluid includes markings and/or a marking agent associated with the criteria identified by the user, (3) then insert the fluid, with the marking agent, into a container provided by the kit, and finally (4) spray the fluid in an appropriate location to, in turn, alleviate the child's fears regarding the monster.

The step of inserting the fluid is different depending upon the type of fluid being introduced, and what type of spray container is being used. In the embodiment shown in FIGS. 1 and 2, container 10 is a conventional spray bottle, capable of spraying any fluid inserted therein. Thus, a user need only open the spray bottle top, and pour the appropriate fluid, along with the marking agent, into the spray bottle. The spray bottle top may then be reconnected, and the spray bottle used as it normally would.

In the embodiment shown in FIG. 3, however, container is a conventional aerosol bottle, in which conventional aerosol refills can be inserted and then sprayed. In using the device shown in FIG. 3, a pre-billed refill is inserted into aerosol shell, and coupled with interface. Once coupled, the contents of refill are released into aerosol shell. Thereafter, a user can simply spray the aerosol canister to release the appropriate fluid there from.

As an alternative method, it fluid 30 does not come pre-mixed with marking agent 32, a different method would be used. As with the previously-described method, the user must first (1) identify an external criteria associated with an occurrence of a negative entity, then (2) select an appropriate marking agent, contained in a dry (or liquid) form in a separate package, (3) combine the marking agent with all appropriate fluid, such as water, then (4) insert the fluid, with the marking agent, into a container provided by the kit, and finally (5) spray the fluid in an appropriate location to, in turn, alleviate the child's fears regarding the monster.

By using the above kit and method, any parent or guardian can provide relief to a child, and possibly help speed the development of that child beyond the fear of fictional negative entities.

The foregoing description merely explains and illustrates the invention and the invention is not limited thereto except insofar as the appended claims are so limited, as those skilled in the art that have the disclosure before them will be able to make modifications without departing from the scope of the invention.

What we claim is:

1. A kit for alleviating fears associated with fictitious negative entities, comprising:
a container having a spray capability;
at least two fluids for insertion into the container, with each fluid having a separate marking agent associated therewith;
wherein each marking agent is associated with one or more predetermined external criteria.

2. The kit according to claim 1 wherein the marking agents comprise dyes of different colors.

3. The kit according to claim 1, wherein the at least one of the at least two fluids comprises a disappearing ink.

4. The kit according to claim 1 wherein the marking agents comprise different scents.

5. The kit according to claim 1 wherein the predetermined external criteria comprise different genders.

6. The kit according to claim 1 wherein the predetermined external criteria comprise the days of the week.

7. The kit according to claim 1 wherein the predetermined external criteria comprise the time of the day.

8. The kit according to claim 1, wherein the predetermined external criteria comprise the month of the year.

9. The kit according to claim 1, wherein the predetermined external criteria comprise public holidays.

10. The kit according to claim 1, wherein the predetermined external criteria comprise different household room names.

11. The kit according to claim 1, wherein the predetermined external criteria comprise different household furniture items.

12. The kit according to claim 1, wherein the predetermined external criteria comprise two or more fictional characters.

13. The kit according to claim 1, wherein the predetermined external criteria comprise two or more non-fictional characters.

14. The kit according to claim 1, wherein the fluid is a liquid.

15. The kit according to claim 1 wherein the fluid is a gas.

16. The kit according to claim 1, wherein the marking agent is premixed with the fluid.

17. The kit according to claim 1, wherein the marking agent is initially separate from the fluid, but capable of mixing with the fluid.

18. The kit according to claim 17, wherein the marking agent comprises mixing tablets.

19. The kit according to claim 17, wherein the marking agent comprises a dissolvable powder.

20. The kit according to claim 17, wherein the marking agent comprises a solvable liquid dye that imparts a color to the fluid.

21. The kit according to claim 1, wherein each fluid is contained in a refill container and the refill container contains identifying markings that correspond to the marking agent.

22. The kit according to claim 1, wherein the container additionally comprises a marking design and the marking design is additionally associated with the predetermined external criteria.

23. A method for alleviating fears associated with fictitious negative entities, comprising:
identifying one or more criteria associated with a fictitious negative entity;
selecting an appropriate fluid based on the criteria, wherein the fluid includes a marking agent associated with the identified criteria;
inserting the fluid into a container having a spray capability; and
spraying the fluid into a predetermined location to, in turn, alleviate fears associated with the fictitious negative entity.

24. The method according to claim 23, wherein the step of identifying criteria comprises the step of identifying the gender of a person affected by the fictitious negative entities.

25. The method according to claim 23, wherein the step of identifying criteria comprises the step of identifying the day of the week in which the fear of the fictitious negative entities occurs.

26. The method according to claim 23, wherein the step of identifying criteria comprises the step of identifying the time of the day in which the fear of the fictitious negative entities occurs.

27. The method according to claim 23, wherein the step of identifying criteria comprises the step of identifying the month of the year in which the fear of the fictitious negative entities occurs.

28. The method according to claim 23, wherein the step of identifying criteria comprises the step of identifying the public holiday with which the fear of the fictitious negative entities is associated.

29. The method according to claim 23, wherein the step of identifying criteria comprises the step of identifying the household room with which the fear of the fictitious negative entities is associated.

30. The method according to claim 23, wherein the step of identifying criteria comprises the step of identifying the household furniture with which the fear of the fictitious negative entities is associated.

31. The method according to claim 23, wherein the step of identifying criteria comprises the step of identifying the fictitious negative entity.

32. The method according to claim 23, wherein the step of identifying criteria comprises the step of identifying a non-fictional character associated with the fear of the fictitious negative entities.

33. The method according to claim 23, wherein the step of selecting an appropriate fluid comprises the step of selecting a fluid having a marking agent that corresponds to the criteria.

34. The method according to claim 23, wherein the step of selecting an appropriate fluid comprises the step of selecting a marking agent that corresponds to the criteria, and associating the marking agent with an appropriate fluid.

35. The method according to claim 34, wherein the fluid comprises a liquid, and the marking agent comprises a mixing tablet, the method further including the step of inserting the mixing tablet into the liquid.

36. The method according to claim 34, wherein the fluid comprises a liquid, and the marking agent comprises a mixing powder, the method further including the step of inserting the mixing powder into the liquid.

37. The method according to claim 34, wherein the fluid comprises a liquid, and the marking agent comprises a miscible dye, the method further including the step of inserting the miscible dye into the liquid.

38. The method according to claim 23, wherein the fluid and the container are contained within a kit, the method including the step of selecting the kit containing an appropriate fluid based on the identified criteria by identifying a marking associated with the kit, which is in turn associated with the identified criteria.

39. The method according to claim 23, wherein the container comprises two or more containers, with each container additionally comprising a marking design associated with the identified criteria, the step of selecting an appropriate fluid comprising the step of selecting an appropriate container based on the marking design, which is in turn associated with the identified criteria.
